(19) United States
(12) Patent Application Publication
(10) Pub. No.: US 2014/0184784 A1
(43) Pub. Date: Jul. 3, 2014

(54) DEFECT INSPECTION DEVICE AND DEFECT INSPECTION METHOD

(71) Applicant: Masakazu Yanase, Osaka-shi (JP)

(72) Inventor: Masakazu Yanase, Osaka-shi (JP)

(73) Assignee: SHARP KABUSHIKI KAISHA, Osaka-shi, Osaka (JP)

(21) Appl. No.: 14/126,016

(22) PCT Filed: May 18, 2012
(86) PCT No.: PCT/JP2012/062781

§ 371 Date: Dec. 13, 2013

(30) Foreign Application Priority Data
Jun. 24, 2011 (JP) 2011-140078

(51) Int. Cl. G01N 21/88; H04N 5/33

(52) U.S. Cl. CPC G01N 21/8803; H04N 5/33
USPC 348/92

(57) ABSTRACT

A defect inspection device of the present invention for detecting a position of a defect existing in a wire formed on a panel, includes: a probe which applies a voltage to a terminal section of the wire; probe moving means for moving the probe to the terminal section; a first infrared sensor which photographs an entire surface of the panel; a second infrared sensor which photographs a part of the panel; and sensor moving means for moving the second infrared sensor to each position on the panel, the first infrared sensor including a plurality of infrared cameras.

### TECHNICAL FIELD

The present invention relates to (i) an inspection device for detecting a defect existing in a wire formed on a panel and (ii) an inspection method for detecting such a defect existing in the wire.

### BACKGROUND ART

A process for producing a liquid crystal panel includes, for example, an array (TFT) step, a cell (liquid crystal) step, and a module step. Among such steps, the array step includes the sub-steps of: (i) forming a gate electrode, a semiconductor film, a source/drain electrode, a protective film, and a transparent electrode on a transparent substrate; and (ii), after the sub-step (i), carrying out an array defect inspection to inspect the array for a defect such as a short circuit or a break existing in electrodes, wires, and the like.

The array defect inspection is generally carried out by a method of bringing a probe into contact with an end part of a wire to measure an electrical resistance across the wire, an electrical resistance between adjacent wires, and an electrical capacitance between adjacent wires. However, although the array defect inspection by the above method can detect whether or not there exists a defect in a wire section, it has a difficulty in identifying a position of the defect.

Examples of an inspection method for identifying the position of the defect encompass a visual inspection in which an operator observes a substrate under a microscope to identify the position of the defect. However, the visual inspection imposes a large burden on the operator and also has the problem of incorrectly identifying the position of the defect due to a difficulty in correctly detecting a defect. As such, there has been proposed an infrared inspection in which an image of the substrate taken with an infrared camera is subjected to image processing so that the position of the defect is identified.

Patent Literature 1 relates to the infrared inspection, and discloses the following technique. That is, according to a thin-film transistor liquid crystal substrate of Patent Literature 1, a short circuit defect 803 is caused to generate heat by applying a voltage V between scanning lines 811 through 815 and signal lines 821 through 825 (see FIG. 9). Meanwhile, before and after the application of the voltage between the scanning lines 811 through 815 and the signal lines 821 through 825, image signals are detected along a broken line 806 under an infrared microscope. Next, a difference between the image signal thus detected before the application of the voltage and the image signal thus detected after the application of the voltage is obtained. Then, projections in respective X and Y directions are calculated. In this way, a pixel address of the short circuit defect 803 is identified.

### CITATION LIST

### Patent Literature

Patent Literature 1
Japanese Patent Application Publication, Tokukaihei, No. 6-51011 A (Publication Date: Feb. 25, 1994)

### SUMMARY OF INVENTION

### Technical Problem

Patent Literature 1 uses an infrared microscope and therefore employs a configuration in which scanning is carried out along the broken line 806. However, Patent Literature 1 has the problem that the infrared inspection of a panel having a large area that needs to be inspected, like a large-sized liquid crystal panel, requires much time and thus reduces productivity.

Therefore, an object of the present invention is to provide a defect inspection device and a method for inspecting a defect, each of which identifies a position of a short circuit defect in a short time, thereby achieving higher productivity than the conventional defect inspection device and the conventional defect inspection method.

### Solution to Problem

In order to attain the object, a defect inspection device of the present invention for detecting a position of a defect existing in a wire formed on a panel, includes: a probe which applies a voltage to a terminal section of the wire; probe moving means for moving the probe to the terminal section; a first infrared sensor which photographs an entire surface of the panel; a second infrared sensor which photographs a part of the panel; and sensor moving means for moving the second infrared sensor to each position on the panel, the first infrared sensor including a plurality of infrared cameras.

In order to attain the object, a method of the present invention for inspecting a defect existing in a wire formed in a panel, includes the steps of: (a) applying a voltage to a terminal section of the wire; (b) photographing, with a plurality of infrared cameras, an entire surface of the panel; and (c) photographing, with one or more infrared cameras, a part of the panel.

### Advantageous Effects of Invention

According to the present invention, it is possible to provide a defect inspection device and a method for inspecting a defect, each of which identifies a position of a short circuit defect in a short time, thereby achieving higher productivity than the conventional defect inspection device and the conventional defect inspection method.

### BRIEF DESCRIPTION OF DRAWINGS

FIG. 1 is a block diagram illustrating main components of a defect inspection device of an embodiment of the present invention.

FIG. 2 is a perspective view illustrating the defect inspection device of the embodiment of the present invention.

FIG. 3 is a perspective view illustrating configurations of a macrosensor and its surroundings.

FIG. 4 is a plan view illustrating a visual field of an infrared camera when viewed from above the liquid crystal panel.

FIG. 5 is a lateral view illustrating a visual field of the infrared camera which visual field is reflected on the liquid crystal panel.

FIG. 6 is a plan view illustrating the liquid crystal panel and a probe.

FIG. 7 is a view illustrating a flow of detecting a short circuit defect by an infrared inspection.

FIG. 8 is a view schematically illustrating a defect existing in a pixel section.

FIG. 9 is a view for explaining a method for identifying an address of a short circuit pixel of the conventional technique.

### DESCRIPTION OF EMBODIMENTS

The following description will specifically discuss an embodiment of the present invention with reference to the drawings. The present embodiment will discuss a defect inspection device which photographs, with use of a plurality of infrared cameras, an entire surface of a liquid crystal panel, thereby eliminating the need for scanning, with an infrared camera, scanning lines and signal lines and reducing a time required for a defect inspection.

Note that the present embodiment will discuss a case where a plurality of liquid crystal panels formed on a mother substrate are subjected to defect inspection. However, the present invention is not limited to this. It is only necessary that a wire is formed on a panel. The method of the present invention for inspecting a defect is applicable to various types of electronic devices including a solar panel.

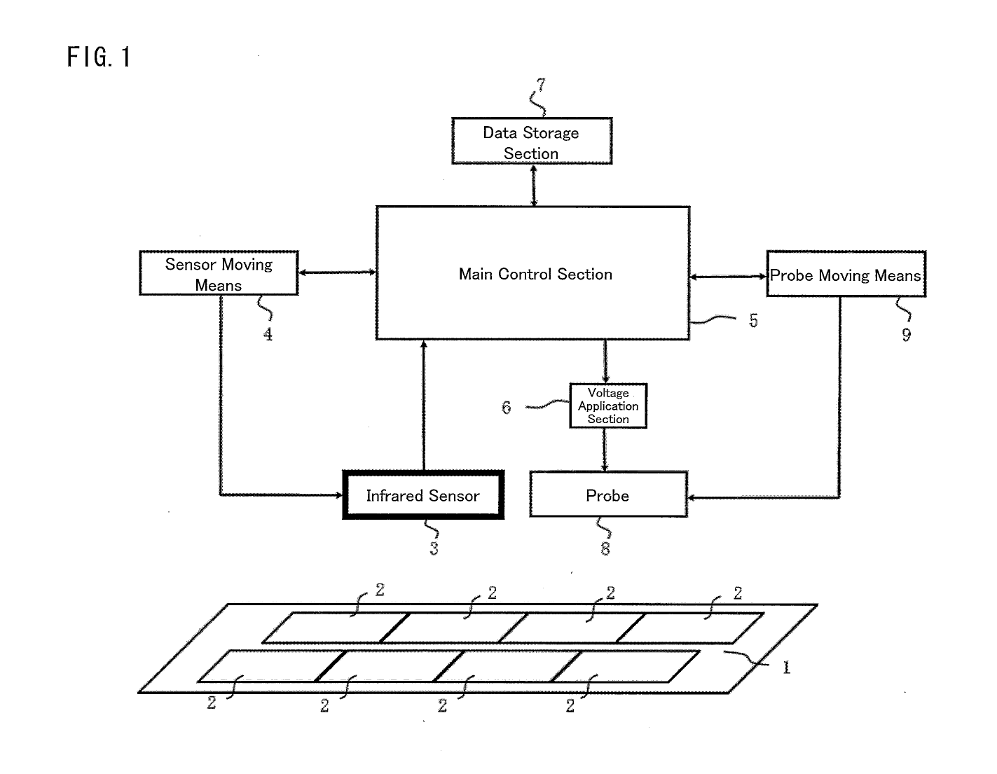

FIG. 1 is a block diagram illustrating main constituent components of a defect inspection device 100 of an embodiment of the present invention. The defect inspection device 100 inspects, one by one in sequence, a plurality of liquid crystal panels 2 formed on a mother substrate 1 for a short circuit defect existing in a wire and the like. The defect inspection device 100 includes an infrared sensor 3, a sensor moving means 4, a main control section 5, a voltage application section 6, a data storage section 7, a probe 8, and a probe moving means 9. Note here that the main control section 5 controls the probe moving means 9, the infrared sensor 3, the sensor moving means 4, and the voltage application section 6. The voltage application section 6 is electrically connected to the probe 8, and applies a voltage to a scanning line and a signal line of each of the liquid crystal panels 2. The data storage section 7 is connected to the main control section 5, and stores data of an image captured by the infrared sensor 3.

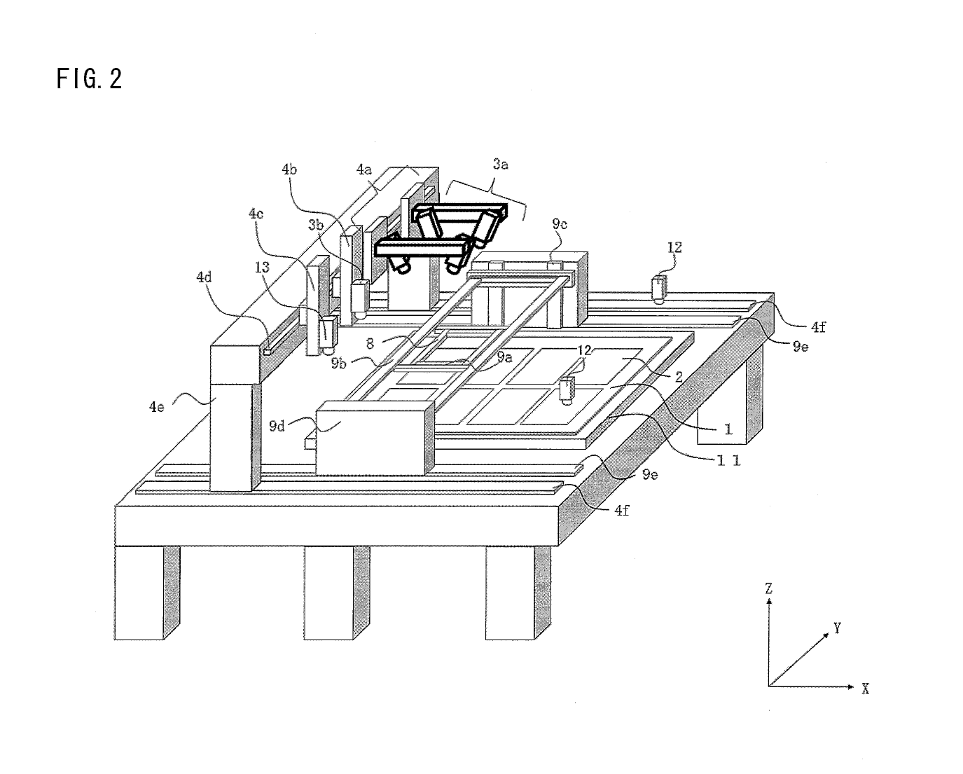

FIG. 2 is a perspective view illustrating the defect inspection device 100 of the present embodiment. The defect inspection device 100 includes, in addition to the main constituent components illustrated in FIG. 1, a substrate alignment stage 11, alignment cameras 12, and an optical camera 13. The mother substrate 1 is placed on the substrate alignment stage 11 by substrate moving means (not illustrated), which adjusts a position of the mother substrate 1. The alignment camera 12 is placed above the substrate alignment stage 11, and confirms the position of the mother substrate 1 under control of the main control section 5 (FIG. 1). The optical camera 13 is controlled by the main control section 5 (FIG. 1) and is used to photograph, as a visible image, a short circuit defect which has been detected by the infrared sensor 3. In addition, the optical camera 13 is used to photograph the probe 8 for alignment.

Note here that the probe 8 applies a voltage to the scanning line and the signal line of each of the liquid crystal panels 2. Moreover, in order to inspect, one by one in sequence, the plurality of liquid crystal panels 2 formed on the mother substrate 1, the probe moving means 9 moves the probe 8 to a position in which the probe 8 comes into contact with a terminal section of each of the liquid crystal panels 2 to be inspected. Furthermore, the probe moving means 9 includes a probe holding section 9a, a gantry guide rail 9b, an upper/lower guide rail 9c, a guide holding section 9d, and a shift guide rail 9e. The gantry guide rail 9b, the upper/lower guide rail 9c, and the shift guide rail 9e each can independently move the probe 8 along a longitudinal direction of each of the guide rails. An xyz coordinate system illustrated in FIG. 2 assumes that a longitudinal direction of the shift guide rail 9e (described later) is an x-axis direction, a longitudinal direction of the gantry guide rail 9b is a y-axis direction, and a longitudinal direction of the upper/lower guide rail 9c is a z-axis direction. On this assumption, the probe holding section 9a retains the probe 8 and is provided so as to be slidable in the y-axis direction of the gantry guide rail 9b. The upper/lower guide rail 9c is provided so that the gantry guide rail 9b is attached to the upper/lower guide rail 9c so as to be slidable in the z-axis direction. The guide holding section 9d retains the upper/lower guide rail 9c and is provided so as to be slidable in the x-axis direction of the shift guide rail 9e.

Furthermore, the infrared sensor 3 obtains an infrared image of each of the liquid crystal panels 2 and includes a macrosensor 3a and a microsensor 3b. The macrosensor 3a includes four infrared cameras, which are used in combination to broaden a visual field. This allows the macrosensor 3a to photograph an entire surface of each of the liquid crystal panels 2 at once. The macrosensor 3a will be specifically described later. Furthermore, the microsensor 3b includes one infrared camera and enables a part of each of the liquid crystal panels 2 to enter a visual field of the microsensor 3b.

Moreover, the sensor moving means 4 moves the infrared sensor 3 above the liquid crystal panel 2 and includes sensor holding sections 4a, 4b, and 4c, a shift guide rail 4d, a guide holding section 4e, and a gantry guide rail 4f. The sensor holding sections 4a, 4b, and 4c retain the macrosensor 3a, the microsensor 3b, and the optical camera 13, respectively. The sensor holding sections 4a through 4c are each provided so as to be independently slidable on the shift guide rail 4d. The shift guide rail 4d is provided so that a long side thereof is in parallel to the y-axis, and the shift guide rail 4d is held by the guide holding section 4e. The guide holding section 4e is provided so as to be slidable on the gantry guide rail 4f. The gantry guide rail 4f is provided so that a long side thereof is in parallel to the x-axis.

The probe moving means 9 and the sensor moving means 4, each of which has a separate guide rail, are movable above the substrate alignment stage 11 without interfering with each other. This makes it possible to further move the macrosensor 3a, the microsensor 3b, and the optical camera 13 above the liquid crystal panel 2 in a state in which the probe 8 is in contact with the liquid crystal panel 2.

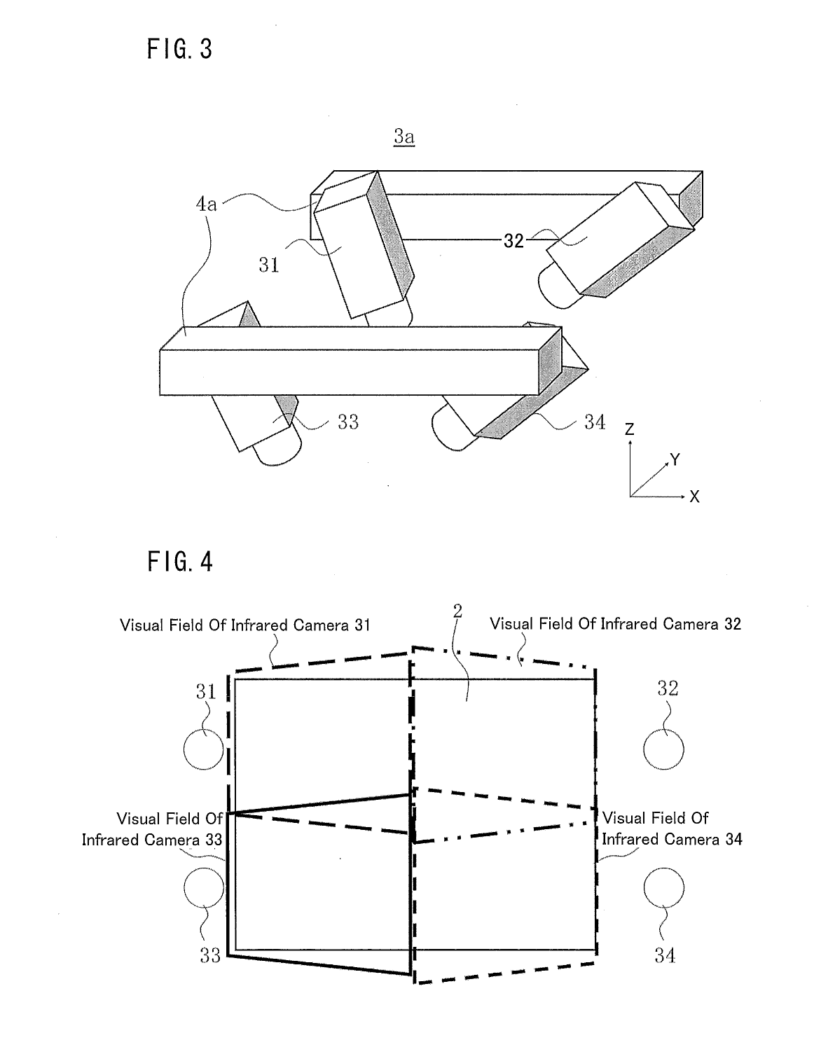

FIG. 3 is a perspective view illustrating a configuration of a macrosensor. The following description will discuss the macrosensor 3a. Note that an xyz coordinate system illustrated in FIG. 3 is identical to that illustrated in FIG. 2. The macrosensor 3a includes four infrared cameras 31 through 34. The infrared cameras 31 through 34 can each incline a center axis of a lens thereof from a direction vertical to the liquid crystal panel 2, so as to prevent photographing, as a heat source, each of the infrared cameras 31 through 34 reflected on the liquid crystal panel 2. The infrared cameras 31 through 34 are provided on the sensor holding section 4a in such positions that the infrared cameras 31 through 34 are located at respective four vertexes of an imaginary rectangle parallel to the substrate alignment stage 11. Moreover, the infrared cameras 31 through 34 each have a rotation axis provided in an identical direction. Furthermore, the center axis of the lens of the infrared camera 31 and that of the lens of the infrared camera 33 are provided in parallel to each other, whereas the center axis of the lens of the infrared camera 32 and that of the lens of the infrared camera 34 are provided in parallel to each other.

FIG. 4 is a plan view illustrating a visual field of each of the infrared cameras 31 through 34 when viewed from above the liquid crystal panel 2. According to the configuration described above, the infrared cameras 31 through 34 each have a visual field in a trapezoid shape. Moreover, an entire surface of each of liquid crystal panels 2 can be photographed by these four infrared cameras 31 through 34 used in combination. Each of images taken with the respective infrared cameras 31 through 34 is subjected to coordinate transformation by the main control section 5 so that a trapezoid shape of the liquid crystal panel 2 shown in each of the images is transformed into a rectangle shape. Subsequently, the main control section 5 determines overlapping regions of the visual fields of the infrared cameras 31 through 34, and then composites the images into one image. Note here that the visual field of the infrared camera 31 overlaps that of the infrared camera 33 only, whereas the visual field of the infrared camera 32 overlaps that of the infrared camera 34 only.

Examples of a method for carrying out a coordinate transformation which transforms, from a trapezoid into a rectangle, a shape of a panel shown in an image encompass a projection transformation. For example, the projection transformation is carried out in the following manner that, when four points of respective four corners of a trapezoid are specified, the trapezoid can be transformed into a rectangle by a matrix operation. Specifically, a transformation matrix is, in advance, calculated and stored. At the time of an actual measurement, the transformation matrix is used to transform a shape of an image into a rectangle shape. A panel actually having a rectangle shape is shown in a trapezoid shape in a camera image. Therefore, the four points of the respective four corners of the panel having a trapezoid shape shown in the camera image are selected. Then, a transformation matrix is calculated by a known operation method so that a quadrilateral constituted by the four points thus selected is a rectangle. The calculation and storage of such a transformation matrix is performed for each camera.

Then, images taken with a plurality of macro cameras, each of which images shows a panel whose shape has been transformed into a rectangle by the projection conversion, are combined into one image (composite image). Information on layout of the images can be calculated and stored in advance. By performing an image processing with respect to the composite image, it is possible to identify a position of a defect existing in the image.

A position of a defect existing in the image can be identified by transforming, by the coordinate transformation, the position of the defect into defect position coordinates in a panel coordinate system (e.g., a panel coordinate system in which a center of the panel is an origin of the panel coordinate system). Specifically, a position of a plumb line of a camera position in the panel coordinate system is calculated based on a position in which the camera is provided. In a case where the camera moves, the position of the plumb line of the camera position is calculated by use of sensor information on a position of a movement axis of the camera. Moreover, a coordinate transformation matrix of (i) the position of the plumb line of the camera position and (ii) each pixel of the composite image is calculated in advance. With use of these pieces of information, it is possible to transform the position of the defect existing in the image into the defect position coordinates in the panel coordinate system.

Note here that the infrared cameras 31 through 34 are not projected in each other unless the liquid crystal panel 2 is provided directly under imaginary straight lines connecting the infrared cameras 31 through 34. Accordingly, the infrared camera 31 and the infrared camera 33 are not projected in each other, whereas the infrared camera 32 and the infrared camera 34 are not projected in each other. Furthermore, the infrared camera 31 and the infrared camera 32 can be provided so as not to be projected in each other (described later).

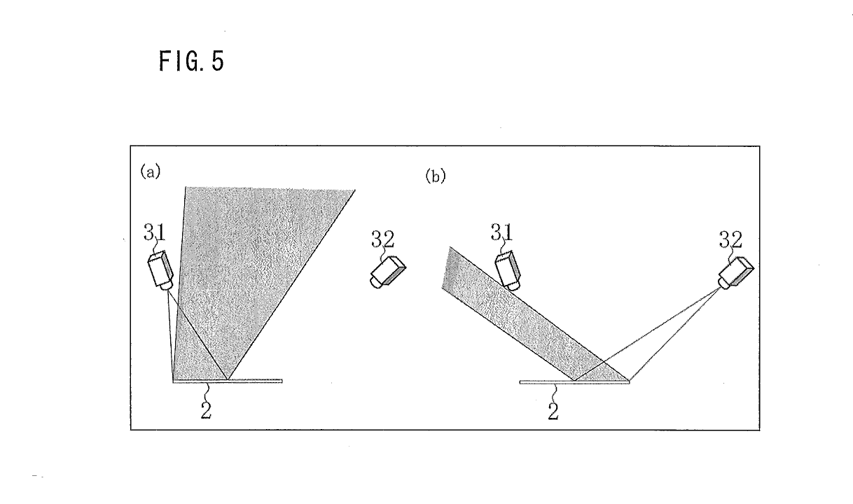

FIG. 5 illustrates an example in which the infrared camera 31 and the infrared camera 32 are provided so as not to be projected in each other. (a) of FIG. 5 is a view illustrating a visual field of the infrared camera 31 and a visual field reflected on the liquid crystal panel 2. (b) of FIG. 5 is a view illustrating a visual field of the infrared camera 32 and a visual field reflected on the liquid crystal panel 2. The infrared camera 32 can be provided, by inclining the center axis of the infrared camera 32 greater than that of the infrared camera 31, so that the infrared camera 31 is not projected in the infrared camera 32. Similarly, the infrared camera 33 and the infrared camera 34 can be provided so as not to be projected in each other. Moreover, it is also possible to provide the infrared camera 31 and the infrared camera 34 so as not to be projected in each other and to provide the infrared camera 32 and the infrared camera 33 so as not to be projected in each other.

As described above, with the arrangement in which the macrosensor 3a includes a plurality of infrared cameras, it is possible to photograph an entire surface of a large-sized liquid crystal panel 2, which is greater in size than a 40-inch panel, at once. This eliminates, unlike the conventional inspection device, the need for scanning, with an infrared camera, a scanning line and a signal line, thus reducing a time required for the defect inspection. Moreover, the arrangement in which the plurality of infrared cameras are provided allows the infrared cameras to be provided in lower positions, as compared with the arrangement in which only one infrared camera is used. This allows the inspection device to be smaller in size. In addition, the arrangement in which the infrared cameras are provided so as not to be projected in each other makes it possible to prevent the infrared cameras from recognizing each other as heat sources.

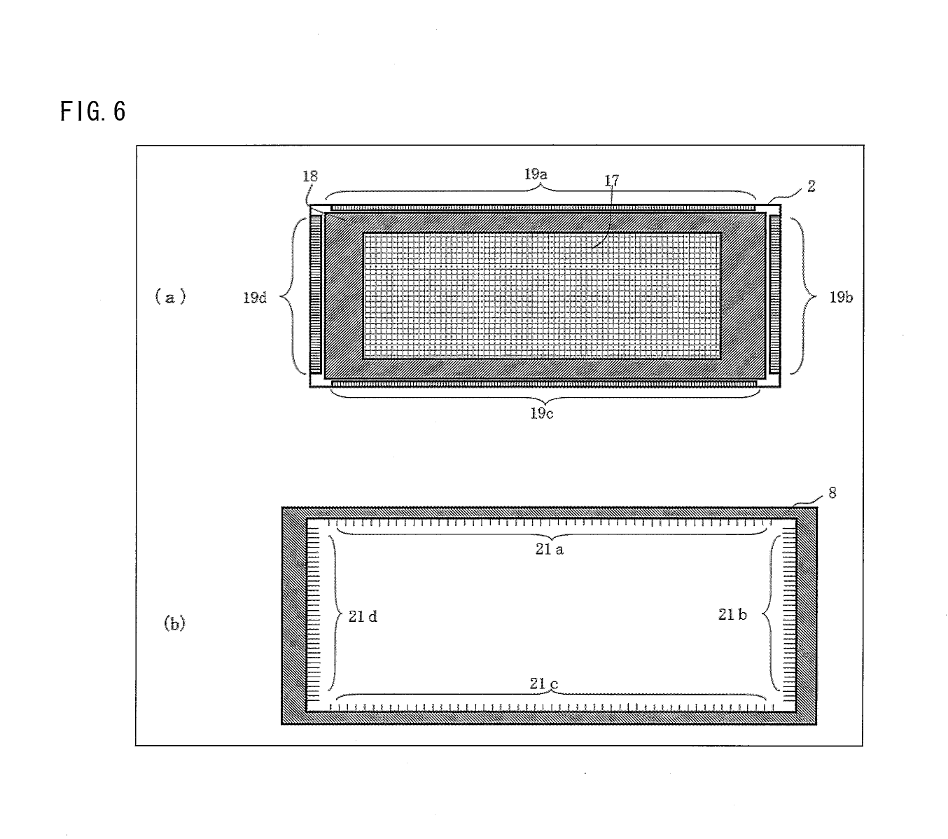

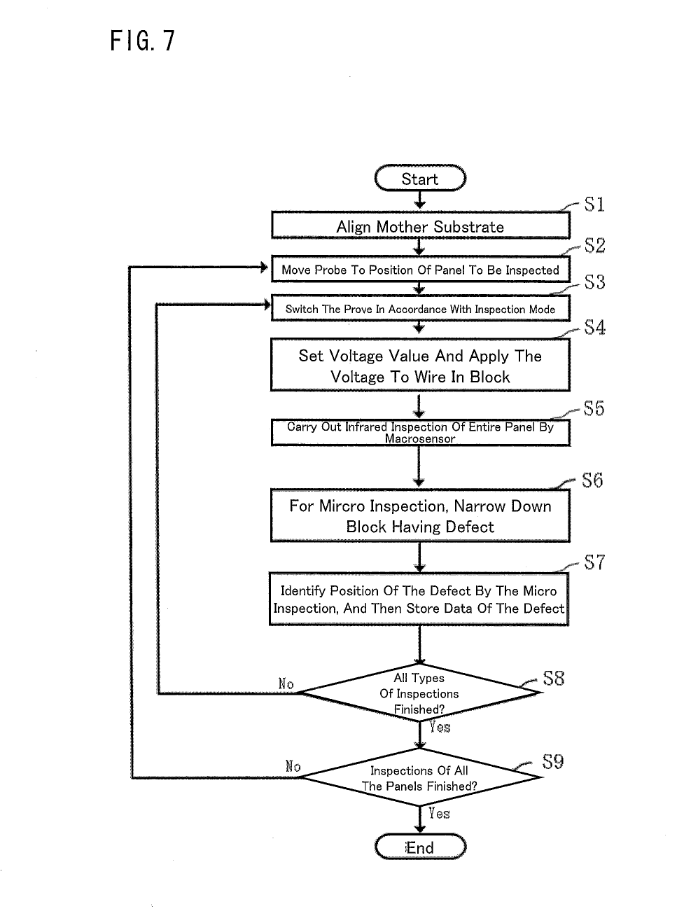

The present embodiment uses a method in which (i) heat generated by a defective part through which an electric current passes upon application of a voltage, via the probe, to the scanning line and the signal line of the liquid crystal panel 2 is measured by the macrosensor 3a and microsensor 3b, and (ii) a position of the defective part is then identified from the heat thus measured. The following description will specifically discuss, with reference to FIG. 6 and FIG. 7, a configuration of the probe and a method for inspecting a defect.

(a) of FIG. 6 is a plan view illustrating the liquid crystal panel 2 formed on the mother substrate 1. The liquid crystal panel 2 includes (i) a pixel section 17 in which TFTs are provided at respective intersections of scanning lines and signal lines and (ii) a peripheral circuit section 18 which drives each of the scanning lines and the signal lines. The liquid crystal panel 2 has terminal sections 19a through 19d provided on its edges, and the terminal sections 19a through 19d are led to each corresponding wire of the pixel section 17 and that of the peripheral circuit section 18.

(b) of FIG. 6 is a plan view illustrating an example of a probe to be conducted with each of the terminal sections 19a through 19d provided on the liquid crystal panel 2. The probe 8 has a frame shape and is substantially identical to the liquid crystal panel 2 in size. Moreover, the probe 8 includes a plurality of probe needles 21a through 21d corresponding to the respective terminal sections 19a through 19d. The plurality of probe needles 21a through 21d are each arranged such that needles of the probe needles 21 each can be individually connected to the voltage application section 6 via a switching relay (not illustrated). With this arrangement, the probe 8 can selectively connect, to the voltage application section 6, a plurality of wires leading to the respective terminal sections 19a through 19d or can collectively connect the plurality of wires to the respective terminal sections 19a through 19d.

Furthermore, the probe 8 has the frame shape and is substantially identical to the liquid crystal panel 2 in size. Hence, in a case where the terminal sections 19a through 19d are to be aligned to the respective probe needles 21a through 21d, the alignment is confirmed, with the optical camera 13, from an inside of a frame section of the probe 8.

FIG. 7 is a view illustrating a flow of detecting a short circuit defect by an infrared inspection. A defect inspection is sequentially carried out, by following steps from S1 (Step 1 is abbreviated to “S1”; the same applies to the subsequent steps.) to S9, with respect to the plurality of liquid crystal panels 2 formed on the mother substrate 1.

In S1, the mother substrate 1 is placed on the alignment stage 11 of the defect inspection device 100. Moreover, a position of the mother substrate 1 is adjusted so that the mother substrate 1 is provided in parallel to an xy coordinate axis. In S2, the probe moving means 9 moves the probe 8 above the liquid crystal panel 2 to be subjected to inspection, so that the probe needles 21a through 21d are brought into contact with the respective terminal sections 19a through 19d of the liquid crystal panel 2.

In S3, a wire is selected in accordance with various defect modes. Moreover, switching of a probe needle to be conducted is carried out among the probe needles 21. In S4, a voltage value to be applied to a wire provided in a defect block 24 is set. The voltage value to be applied to the wire is adjusted by the voltage application section 6. Usually, a voltage of approximately several tens of volts is applied.

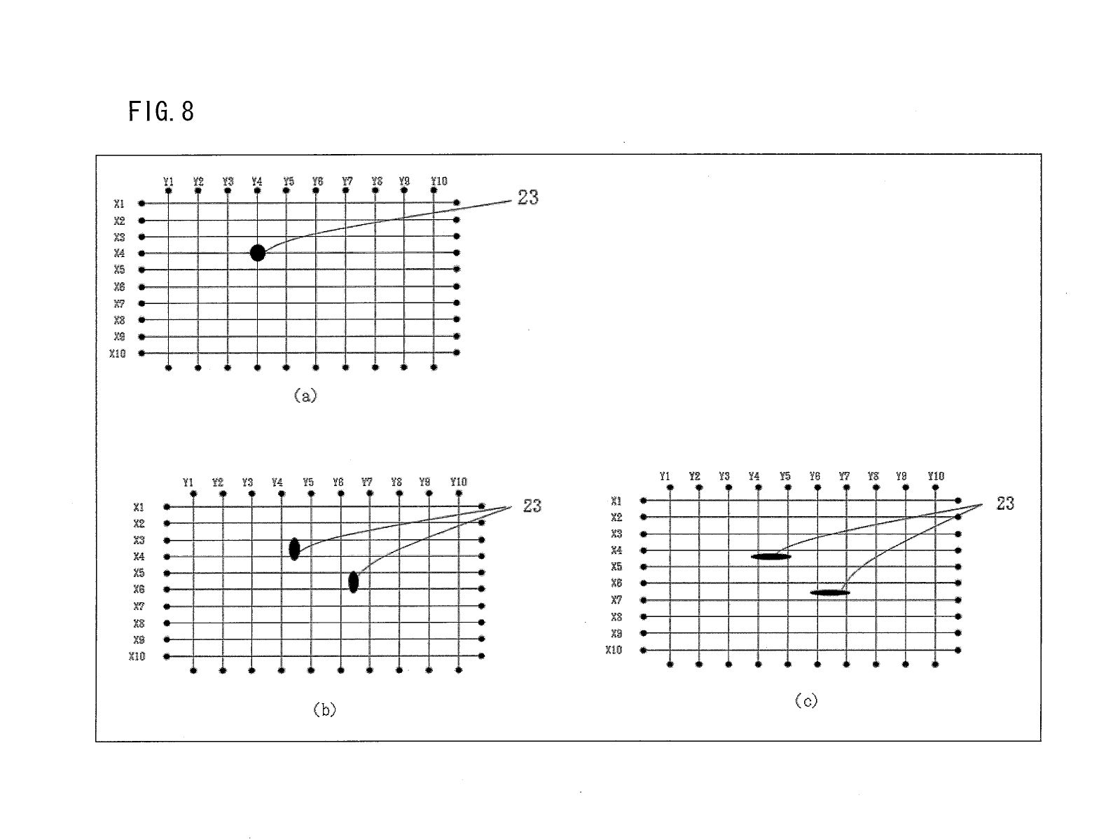

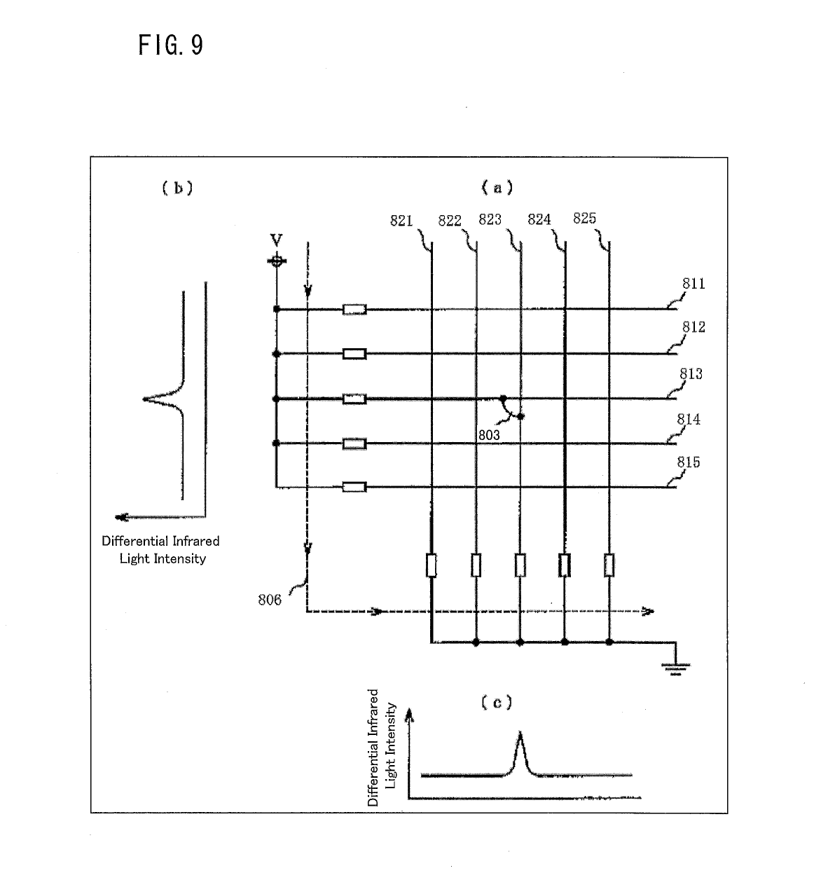

FIG. 8 schematically illustrates, as an example, a position of a defect which can occur in the pixel section 17. (a) of FIG. 8 illustrates a defect 23 in which a short circuit occurs at a position in which a wire X and a wire Y intersect with each other so as to be positioned on top of each other, as with a scanning line and a signal line, for example. As to such a defect 23, an electric current passes through the defect 23 by switching the probe needles 21 to be conducted between the probe needles 21a and 21d and the probe needles 21b and 21c (see FIG. 6). The passage of the electric current through the defect 23 generates heat.

(b) of FIG. 8 illustrates a defect 23 in which a short circuit occurs between wires X, which are adjacent to each other, as with a scanning line and an auxiliary capacitance line, for example. As to such a defect 23, an electric current passes through the defect 23 by switching the probe needles 21 to be conducted between odd-numbered probe needles 21b and even-numbered probe needles 21d. The passage of the electric current through the defect 23 generates heat.

(c) of FIG. 8 illustrates a defect 23 in which a short circuit occurs between wires Y, which are adjacent to each other, as with a signal line and an auxiliary capacitance line, for example. As to the defect 23, an electric current passes through the defect 23 by switching the probe needles 21 to be conducted between odd-numbered probe needles 21a and even-numbered probe needles 21c. The passage of the electric current through the defect 23 generates heat.

In S5, the macrosensor 3a carries out an infrared inspection of the entire surface of the liquid crystal panel 2. Note here that the macrosensor 3a can narrow down a position of the defect 23 by detecting infrared light emitted from the defect 23. This makes it possible to measure the entire surface of the liquid crystal panel 2 without scanning the macrosensor 3a, thereby reducing a time required for the infrared inspection.

In S6, the sensor moving means 4 moves the microsensor 3b so that the defect detected in S5 is included in a visual field of the microsensor 3b. The microsensor 3b, which is an infrared camera for micro measurement, (i) is an infrared camera which can carry out higher resolution photographing than the macrosensor 3a does and (ii) can carry out micro measurement. As to accuracy of detection of defect position by the macrosensor 3a, accuracy in which a defect is included in an image visual field of the microsensor 3b is realized. Moreover, a more accurate defect position is identified by carrying out the micro measurement by the microsensor 3b. In S7, the microsensor 3b carries out an infrared inspection of a part of the liquid crystal panel 2. The defect 23 generating heat through the passage of an electric current is photographed with the microsensor 3b. This causes infrared light emitted from the defect 23 to be detected. Since the macrosensor 3a has narrowed down a position of a part in which heat is generated, the microsensor 3b can be directly aligned to the part in which heat is generated. This makes it possible to further specifically measure, in a short time, information, such as a type of detect, required for correcting the defect 23. In heat images measured (i.e., an image obtained by the macrosensor and an image obtained by the microsensor), the defect 23 is displayed with its temperature higher than that of an area peripheral to the defect 23. Therefore, a position of the defect is identified based on a positional relationship between the defect 23 and the wire, and the position of the defect thus identified is stored in the data storage section 7.

In S8, as to the liquid crystal panel 2 which is being inspected, it is determined whether or not all inspections for various defect modes have been finished. In a case where a defect mode for which inspection has not yet been carried out is found, the process returns to S3, in which the connection of the probe 8 is switched in accordance with the remaining defect mode, so that the defect inspection for that mode is carried out.

In S9, as to the mother substrate 1 which is being inspected, it is determined whether or not array defect inspections of all the liquid crystal panels 2 have been finished. In a case where a liquid crystal panel 2 for which inspection has not yet been carried out is found, (i) the process returns to S1, in which the probe is moved to a liquid crystal panel 2 which is to be next subjected to inspection, so that the defect inspection of that liquid crystal panel 2 is carried out.

Note that the number of infrared cameras included in the macrosensor of the present invention is not limited to that of the infrared cameras of the present embodiment. Alternatively, the macrosensor can include five or more infrared cameras.

Moreover, a direction in which the macrosensor of the present invention is provided is not limited to that of the present embodiment. Alternatively, the macrosensor can be provided so that the center axis of the lens of the camera is provided in a vertical direction to the ground surface. This is because even in a case where one of the infrared cameras 31 through 34, each of which is reflected on the liquid crystal panel 2, is projected as a heat source in any of the others of the infrared cameras 31 through 34, a projection image in which each of the infrared cameras 31 through 34 is projected as a heat source is canceled out to a certain extent by obtaining a difference between an image obtained before application of a voltage to the liquid crystal panel 2 and an image obtained after application of the voltage to the liquid crystal panel 2.

The present invention is not limited to the description of the embodiments above, but may be altered by a skilled person within the scope of the claims. That is, a new embodiment can be obtained from a proper combination of altered technical means within the scope of the claims. That is, the embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

(Overview of the Present Invention)

As described above, the defect inspection device of the present invention for detecting a position of a defect existing in a wire formed on a panel, includes: a probe which applies a voltage to a terminal section of the wire; probe moving means for moving the probe to the terminal section; a first infrared sensor which photographs an entire surface of the panel; a second infrared sensor which photographs a part of the panel; and sensor moving means for moving the second infrared sensor to each position on the panel, the first infrared sensor including by a plurality of infrared cameras.

In addition to the configuration, the defect inspection device of the present invention can be configured such that the infrared cameras are provided in such positions so as to prevent each of the infrared cameras reflected on the panel from being projected in the other infrared cameras.

In addition to the configuration, the defect inspection device of the present invention can be configured to further include: a control section which processes a plurality of images taken by photographing with the infrared cameras, the control section determining overlapping regions of visual fields of the infrared cameras and then compositing the plurality of images taken with the infrared cameras into a single image of an entirety of the panel.

The method of the present invention for inspecting a defect existing in a wire formed in a panel, includes the steps of: (a) applying a voltage to a terminal section of the wire; (b) photographing, with a plurality of infrared cameras, an entire surface of the panel; and (c) photographing, with one or more infrared cameras, a part of the panel.

In addition to the configuration, the method of the present invention can be configured such that the step (b) carries out photographing in such a manner so as to prevent each of the infrared cameras reflected on the panel from being projected in the other infrared cameras.

In addition to the configuration, the method of the present invention can be configured to further include the steps of: (d) determining overlapping regions of visual fields of the infrared cameras; and (e) compositing the plurality of images taken with the infrared cameras into a single image of an entirety of the panel.

### INDUSTRIAL APPLICABILITY

The present invention can provide a defect inspection device and a method for inspecting a defect, each of which identifies a position of a short circuit defect in a short time, thereby achieving higher productivity than the conventional defect inspection device and the conventional defect inspection method.

Therefore, the method of the present invention for inspecting a defect can be applicable to various types of electronic devices including a liquid crystal panel and a solar panel.

### REFERENCE SIGNS LIST

1: Mother substrate
2: Liquid crystal panel (panel)
3: Infrared sensor
3a: Macrosensor
31, 32, 33, 34: Infrared camera
3b: Microsensor
4: Sensor moving means
5: Main control section
6: Voltage application section
7: Data storage section
8: Probe
9: Probe moving means

1. A defect inspection device for detecting a position of a defect existing in a wire formed on a panel, comprising:
a probe which applies a voltage to a terminal section of the wire;
probe moving means for moving the probe to the terminal section;
a first infrared sensor which photographs an entire surface of the panel;
a second infrared sensor which photographs a part of the panel; and
sensor moving means for moving the second infrared sensor to each position on the panel,
the first infrared sensor including a plurality of infrared cameras.

2. The defect inspection device as set forth in claim 1, wherein the infrared cameras are provided in such positions so as to prevent each of the infrared cameras reflected on the panel from being projected in the other infrared cameras.

3. The defect inspection device as set forth in claim 1, further comprising:
a control section which processes a plurality of images taken by photographing with the infrared cameras,
the control section determining overlapping regions of visual fields of the infrared cameras and then compositing the plurality of images taken with the infrared cameras into a single image of an entirety of the panel.

4. A method for inspecting a defect existing in a wire formed in a panel, comprising the steps of:
(a) applying a voltage to a terminal section of the wire;
(b) photographing, with a plurality of infrared cameras, an entire surface of the panel; and
(c) photographing, with one or more infrared cameras, a part of the panel.

5. The method as set forth in claim 4, wherein the step (b) carries out photographing in such a manner so as to prevent each of the infrared cameras reflected on the panel from being projected in the other infrared cameras.

6. The method as set forth in claim 4, further comprising the steps of:
determining overlapping regions of visual fields of the infrared cameras; and
compositing the plurality of images taken with the infrared cameras into a single image of an entirety of the panel.

7. The defect inspection device as set forth in claim 2, further comprising:
a control section which processes a plurality of images taken by photographing with the infrared cameras,
the control section determining overlapping regions of visual fields of the infrared cameras and then compositing the plurality of images taken with the infrared cameras into a single image of an entirety of the panel.

8. The method as set forth in claim 5, further comprising the steps of:
determining overlapping regions of visual fields of the infrared cameras; and
compositing the plurality of images taken with the infrared cameras into a single image of an entirety of the panel.
